(19) United States
(12) Patent Application Publication
(10) Pub. No.: US 2008/0028553 A1
(43) Pub. Date: Feb. 7, 2008

(54) Training toothbrush with audio

(76) Inventor: Julie A. Batthauer, Daleville, IN (US)

Correspondence Address: RITCHISON LAW OFFICES, PC;John D. Ritchison, Suite A, 115 East Ninth Street, Anderson, IN, 46016-1509, US

(21) Appl. No.: 11/810,624

(22) Filed: Jun. 6, 2007

Related U.S. Application Data
(60) Provisional application No. 60/812,931, filed on Jun. 13, 2006.

(51) Int. Cl. A46B 15/00; G09B 15/00

(52) U.S. Cl. 15/105; 434/263

(57) ABSTRACT

A toothbrush device used for a unique teaching method for proper teeth brushing techniques by means of prerecorded audio commands emanating from the handle of the toothbrush. The toothbrush with audio is a product that is designed to easily and quickly provide a new and unique motivation for young children to brush their teeth correctly. This special toothbrush combined with an integral audio device to encourage and coach children on proper tooth brushing habits. The configuration comprises a handle that is slightly larger than a conventional toothbrush and the handle contains a waterproof speaker, a power switch, and a battery compartment. The extension neck and bristle are similar to conventional toothbrushes.

### CROSS-REFERENCE TO RELATED APPLICATIONS

The present invention was first described in Disclosure Document No. 582,330 that was filed on Jul. 21, 2005. This application claims the benefit of Provisional Patent Application Ser. No. 60/812,931 that was filed Jun. 13, 2006 by Julie A. Batthauer, and titled “Training Toothbrush with Audio”.

### FIELD OF INVENTION

This invention relates generally to a device used for a unique teaching method for proper teeth brushing techniques and dental hygiene and, more particularly, by means of prerecorded audio commands emanating from the handle of the toothbrush, especially for young children.

### FEDERALLY SPONSORED RESEARCH

None.

### SEQUENCE LISTING OR PROGRAM

None.

### BACKGROUND

### Field of Invention

The new Training Toothbrush with Audio described in this specification is a product that is designed to easily and quickly provide a new and unique motivation for children to brush their teeth correctly.

A. Introduction of the Problems Addressed

The benefits of brushing one's teeth are well known to all. Brushing removes food particles, removes plaque on and between teeth, and is the primary tool for improving dental hygiene. Brushing also massages the gums and prevents various forms of gum disease. Historically, dental hygiene was accomplished with a fixed toothbrush that one held and manipulated by hand. Visits to a dentist or dental hygienist allowed more thorough cleaning with mechanized brushing and other means. In recent years, powered tooth brushes that moved in a linear “back and forth” motion were introduced. More recently, rotating brushes for home use have been introduced. None have come with an audio assist that helped to instruct the user.

Many people learn good dental hygiene habits when they are young and are under the guidance of a parent or care provider. Such guidance typically includes encouragement and coaching on how to do a better job and how to concentrate on all teeth in one's mouth, and not just the front teeth. However, in today's busy world, parents and care providers may not always have the time to spend with a child to teach and coach them every time they brush their teeth. Accordingly, there is a need for a means by which proper encouragement and coaching can be provided to children who are brushing their teeth without the necessity of a parent or care provider to always be present. The development of the invention herein disclosed fulfills this need.

B. Prior Art

In recent years, some training aids to the brushing of teeth have been offered by various means. Examples of prior aids to brushing begin with U.S. Pat. No. 4,253,212 issued to Fujita (1981). This teaches a training appliance for tooth brushing that emits a sound signal or light signal to indicate the reciprocal “stroke” is sufficient and appropriate. There is no anticipation or description of audio instruction or a timing device such as in the Training Toothbrush with Audio. Another improvement for tooth care was issued to Scheiner as U.S. Pat. No. 5,572,762 (1996). It teaches a tooth brush with a sound or light (LED) generator in the handle. It mentions a buzzer, a bell and light. It mentions the possibility of synthesized sound for instruction but does not claim any specific areas of instruction or anticipate encouraging directions to a child. The Training Toothbrush with Audio focuses on the encouragement to children and a timed set of repeated motivational statements from an audio chip device in the handle.

Other examples of training brushes include a U.S. Pat. No. 6,397,424 issued to Leung (2002) which teaches a light device that indicates the stroke of the brush is up and down. It is useful to young people but offers only a visual signal and no motivational sound bites or encouragement. A U.S. Pat. No. 5,924,159 issued to Haitin (1999) teaches a toothbrush including a motion sensor, mounted in the brush, and arranged to provide output signals corresponding to movements of the brush, an audible signal generator, and a controller which activates the signal generator in response to the output signals from the motion sensor. The sounds described are melodies and no words of encouragement or motivation to complete the two minute session as in the present invention.

A Sound-producing toothbrush assembly was shown in U.S. Pat. No. 4,341,230 issued to Siahou. It taught a sound-generating toothbrush adapted to increase the efficiency of tooth brushing as well as to direct the functional senses for cleaning from top to bottom with translational pressure. The device comprised a container including a sound-producing system and was adapted to receive a toothbrush or similar instrument into the container. Another tooth brush device is taught in U.S. Pat. No. 4,744,124 issued to Wang et al (1988) that teaches a tooth brush with a musical tone and no words of encouragement or direction. There was no timer or period of playing the music described.

A rigorous and complex tooth brush system was shown and taught by the U.S. Pat. No. 5,673,451 issued to Moore et al (1997). The patent taught an instructional tooth brush that was adapted to serve as an aid to encourage tooth brushing and to reinforce recommended tooth brushing technique. The toothbrush comprised a body having an electrical subassembly incorporating a visual indicator such as a light or a light emitting diode, and a switching unit within the electrical subassembly for selectively activating the visual indicator only when the toothbrush is being used according to recommended tooth brushing technique. Alternate embodiments included buzzers and other sound emitters. No teaching of a device with words or oral encouragements are indicated with this complex device. A U.S. Pat. No. 6,754,928 issued to Rosen (2004) was focused on a complex toothbrush device for reinforcing brushing behavior. It included a motion sensing means electrically connected to a brushing logic means, which determines generalized brushing action of a user/child. After the logic requirements of motion sensing are complete, the logic means directs a digital output display means to output to a small screen or speaker and a visual and/or audible reward to the user closely tied to games and other “fun” activities. The lights, sounds and complex controls show a combination far more expensive and complex to produce when compared to the present Training Toothbrush with Audio device shown here.

As far as is known, there are no special Training Toothbrush with Audio device or the like. Equally significant is that there are no known products or methods taught with a combination of features that accomplishes the same or similar production processes taught in this invention. It is believed that this product is unique in its design and technologies. The search of prior art revealed no patent or a patent in view of another patent that had the combination of this invention. Prior art did not anticipate these features and functionality demonstrated by the Training Toothbrush with Audio.

### SUMMARY OF THE INVENTION

The present invention is a special toothbrush combined with an integral audio device to encourage and coach children on proper tooth brushing habits. Upon initial observation of the invention, it appears like a conventional toothbrush with a handle, extended shaft and brushing bristles. However, after closer observation, it can be seen that the handle is slightly larger than a conventional toothbrush and the handle contains a waterproof speaker, a power switch, and a battery compartment.

Upon turning on and energizing the toothbrush, the device begins to annunciate various, encouraging phrases, such as “Good Job”, or coaching type statements such as “Now Get The Back Teeth” to help children, and anyone else, do a better job of brushing their teeth. The phrases, which are a series of sequentially generated pre-recorded coaching messages, would continue and then cease after a suitable time period, approximately two minutes. At this point the child would know he or she has completed the task and could rinse the toothbrush and then put the toothbrush away. The use of this novel training device and methodology assist children to do a better job of brushing their teeth, to brush for the proper amount of time (essentially two (2) minutes, and to complete the task without supervision.

### OBJECTS AND ADVANTAGES

There are several objects and advantages of the Training Toothbrush with Audio product as shown below. The following TABLE A summarizes various advantages and objects of the Training Toothbrush with Audio device. This list is exemplary and not limiting to the many advantages offered by this new device.

TABLE A
Various Advantages and Objects

| Item | | Description of Advantage and Object |
|---|---|---|
| 1 | Fun | May be used to make the brushing |
| | | fun for the child |
| 2 | Promotes Hygiene | Focuses on the importance to dental |
| | | and general health associated with |
| | | dental hygiene |
| 3 | Instructs/teaches | Provides a way to send information, |
| | | instruction and guides re: oral |
| | | hygiene to the user |
| 4 | Optional Battery | Permits actual usage when away from |
| | powered | electricity |
| 5 | Economical | Mass produced |
| 6 | Saves time | Instructs the user (child) with or |
| | | without parental presence |

Noteworthy is that other advantages and additional features of the present Training Toothbrush with Audio will be more apparent from the accompanying drawings and from the full description of the device. For one skilled in the art of teeth care and maintenance, it is readily understood that the features shown in the examples with this product and process are readily adapted to other types of teeth care products and processes.

### DESCRIPTION OF THE DRAWINGS

### Figures

The accompanying drawing, which is incorporated in and constitute a part of this specification, illustrates an embodiment of the Training Toothbrush with Audio that is preferred. The drawing together with the summary description given above and with the detailed description given below all serve to explain the principles of the Training Toothbrush with Audio device. It is understood, however, that the Training Toothbrush with Audio device is not limited to only the precise arrangements and instrumentalities shown.

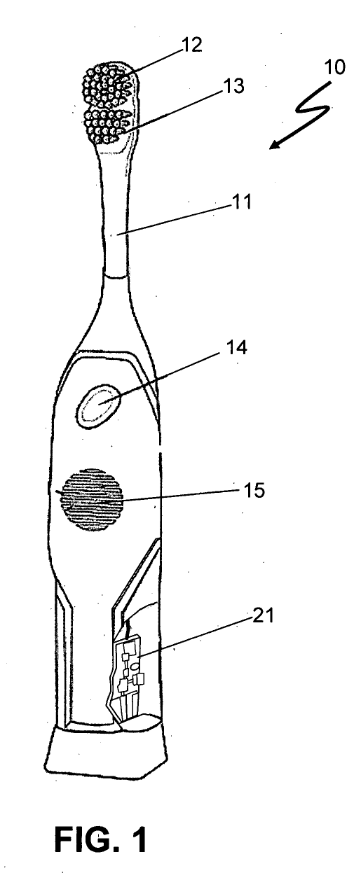

FIG. 1 is a pictorial representation of the training toothbrush system with audio shown fully assembled in its entirety, with a toothbrush head, according to the preferred embodiment of the present invention.

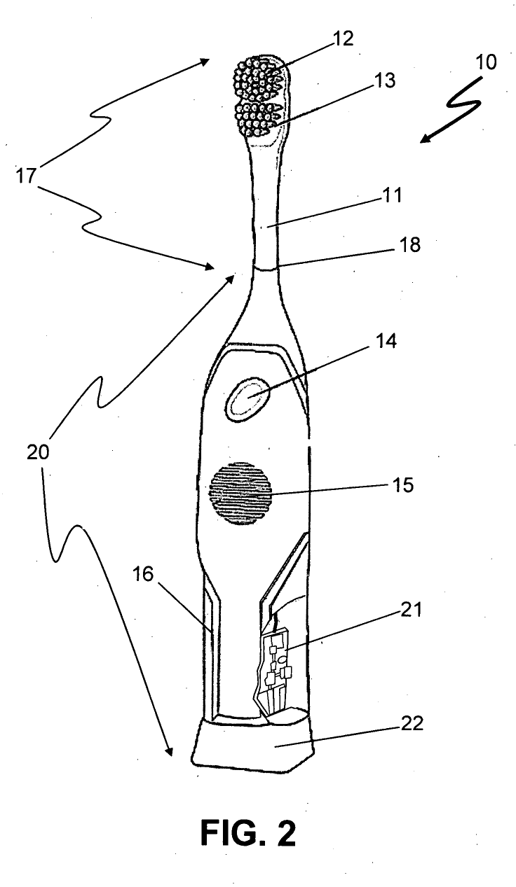

FIG. 2 is a pictorial representation of the training toothbrush system with components and general assembly depicted.

### DESCRIPTION OF THE DRAWINGS

### Reference Numerals

The following list refers to the drawings:

| No. | Item |
|---|---|
| 10 | training toothbrush system with audio |
| 11 | neck |
| 12 | bristles |
| 13 | toothbrush head |
| 14 | On/off button |
| 15 | speaker grille |
| 16 | Handle or grip in general |
| 17 | Brush assembly |
| 18 | Means to connect brush assembly 17 to body 20 |
| 20 | toothbrush body |
| 21 | audio microchip |
| 22 | Power source access (battery or cord or the like) |

### DETAILED DESCRIPTION OF PREFERRED EMBODIMENT

The present development is a product and method for a person, in particularly a young person, to be instructed and improve dental hygiene. The device is called a Training Toothbrush with Audio device 10. Particularly this product is related to a special alteration to a toothbrush assembly that includes an audio training system.

The improvement over the existing art is providing a device that:

a. is fun;

b. promotes hygiene;

c. instructs and teaches good dental hygiene; s;

d. has optional power means such as battery powered devices; and

e. is economical to use.

The best mode for carrying out the invention is presented in terms of its preferred embodiment, herein depicted within FIGS. 1 and 2. The present invention describes an apparatus 10 and method for providing training on the tooth brushing technique for better health and hygiene of children's teeth. The training toothbrush system with audio (herein described as the “apparatus”) 10 is comprised of:
a toothbrush head 13 with a bristle arrangement 12 called a brush assembly 17;
a toothbrush body assembly 20 with an on/off switch 14, a handle grip 16, an audio grille 15, an audio chip 21, and a power access 22; and,
a means to connect 18 the brush assembly 17 and the body assembly 20 to provide a rigid and secure Training Toothbrush with Audio device 10.

Referring now to FIG. 2, a pictorial representation of the apparatus 10 shown assembled with components and general assembly depicted. The apparatus 10 in its entirety with a toothbrush head 13, according to the preferred embodiment of the present invention is disclosed. The apparatus 10 is envisioned to be utilized by children and/or other beginning tooth brushers alike to optimize proper tooth brushing technique. The body of apparatus 10 is envisioned to be made that of a variety of plastics, rubber for sealing, and/or other materials, including composite materials, that are suitable for providing a means for water proofing or resisting moisture intrusion.

The head 13 of the toothbrush is generally aligned with the longitudinal axis of the apparatus 10 and envisioned to comprising a plurality of tufted bristles 12, embedded thereto, and adapted onto distinct movable parts that each and together provide optimum oral health benefits thereof. The bristles 12 may be tufted in a variety of sizes and/or configurations, including the disc shape depicted in FIGS. 1 and 2, though many other shapes are envisioned, including oval or various other regular or irregular shapes. The bristle tufts 12 is envisioned to be made of a same or different bristle 12 materials found in common toothbrushes such as nylon or polyesters.

A neck 11 is further formed between the handle grip 16 portion of the toothbrush body 20 and the brush assembly 17, comprised of the head 13 and bristles 12. The head 13 is coupled to a drive mechanism within the body assembly 20 such as to transpire oscillation of the head 13 and subsequently the bristles 12 in a back and forth direction, rotational direction, and/or other movements providing a recommended tooth brushing technique. The neck 11 and body assembly 20 handle 16 may be constructed as a unitary constituent. An alternate embodiment of the toothbrush is envisioned to include a separate head 13 insert which can therefore be removed and replaced for other users or other temporary or permanent purposes such as cleaning and servicing. The brush assembly 17 with the tooth brush head 13 and body assembly 20 are envisioned to comprise of a connector linkage and means to connect 18 modified to be detachably united in accordance with each. The connector linkage may be between the head 13 and neck 11 or alternatively between the neck 11 and body 20.

The toothbrush body 20 includes a handle 16 at a proximal end thereof in which may include grips or recessed finger sections shaped to accommodate an average person's hand. The toothbrush body 20 also defines an interior compartment for housing electrical subassembly for selectively activating an aural indicator, such as an audio microchip 21. The activation of the driving mechanism built therein to the apparatus 10 and the audio microchip 21 occurs upon by depressing the on/off button 14 or by other means such as, but not limited to, a rocker switch into the “on” position. The on/off switch 14 comprises an electronic switch member and a water impermeable membrane covering the electronic switch member to prevent water damage to the sound generating device and the electronic switch member. The audio microchip 21 comprises of pre-recorded recorded coaching instructions in which is transmitted there through amplified speakers (not illustrated) located behind the speaker grille 15. The pre-recorded instructions coaches the child and/or other user in proper tooth brushing technique with verbal encouragement imperative for optimum feedback. The verbal encouragement would comprise of phrases such as, but are not limited to, “Good Job”, “That's Great”, “Wonderful” incorporated within consistent tooth brushing technique coaching for the optimal development. The coaching statements would comprise of statements such as, but are not limited to “Now get the back teeth”, “Scrub them the same way”, “Go to the bottom teeth” to assist children or other users to perform better tooth brushing technique. The audio chip 21 has a means such as an electrical circuit and components for generating audible and encouraging words and sounds plus a timer device for activating the electrical circuit to generate words and sounds for a predetermined time period.

The body 20 may house a motor (not illustrated) operatively connected to the driving mechanism and a source to power the motor (such as a battery pack such as one or more batteries or electrical cord through access 22) and audio microchip 21. The batteries may be of disposable or rechargeable use, with preference towards rechargeable.

Yet, another embodiment of the present apparatus 10 comprises an integral rechargeable battery pack in the base of the body 20 with means to recharge said battery pack on a base unit connected to a conventional power supply via an electrical cord.

### OPERATION OF THE PREFERRED EMBODIMENT

The preferred embodiment of the present invention 10 can be utilized by the common user in a simple and effortless manner with little or no training. Likewise, children and/or other beginning tooth brushers alike can find this invention to greatly aid them in brushing. After initial purchase or acquisition of the Training Toothbrush with Audio device 10, it would be assembled as indicated in FIG. 1 or the brush assembly 17 may be disassembled therefrom the body 20 at the means to connect 18 for replacement of the brush assembly 17.

The method of utilizing the device may be achieved by performing the following steps: applying toothpaste thereon the bristles 12; powering the apparatus 10 by depressing the on/off button 14 or switch to the “on” postion; and, following the coaching instructions.

More specifically, a method of utilizing the device may be achieved by performing the following steps:

| Step | Action |
|---|---|
| 1 | inserting the rechargeable batteries therein |
| | the apparatus 10 |
| 1A | Or alternatively, plugging the apparatus 10 |
| | into an electric outlet |
| 2 | inserting the desired toothbrush head 13 |
| | therein the body 20 utilizing the connector |
| | linkage |
| 3 | applying toothpaste thereon the bristles 12 |
| 4 | powering the apparatus 10 after charging by |
| | depressing the on/off button 14 or rocker |
| | switch to the “on” position |
| 5 | following the coaching instructions throughout |
| | the entire duration envisioned to be |
| | approximately two (2) minutes as recommended by |
| | the American Dental Association |
| 6 | rinsing off the bristles 12 embedded therein |
| | the head 13 |
| 7 | storing appropriately including plugging the |
| | apparatus 10 into an electric outlet for |
| | charging if battery powered and rechargeable |
| 8 | Repeat at appropriate time |

The apparatus 10 may be plugged into an electrical outlet or battery operated. The batteries may be of disposable use and not rechargeable. In which case, the plugging of the apparatus 10 therein an electric outlet is not necessary.

In summary, the training toothbrush with audio 10 is a training apparatus which instructs children and/or beginning tooth rushers alike in the proper brushing technique. The apparatus 10 instructs and coaches the child and/or beginning tooth brusher enabling the absence of a parent or other supervisory subjects. These pre-recorded coaching instructions, which are transmitted there through speakers located behind a speaker grille 15, coaches the child and/or other users in proper tooth brushing technique with verbal encouragements imperative for optimum feedback. The audio microchip 21 built therein the toothbrush body 20 comprises the pre-recorded coaching instructions. The toothbrush body 20 includes a handle 16 at a proximal end thereof in which may include grips or recessed finger sections thereby providing a comfortable circumstance and assisting in the proper hand placement.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

What is claimed is:

1. An apparatus 10 for the training and positive reinforcement of proper teeth brushing techniques by means of pre-recorded audio commands.

2. The object according to claim 1 wherein the apparatus is a toothbrush 10 comprising:
(a) a toothbrush head 13 with a bristle arrangement 12 called a brush assembly 17;
(b) an elongated toothbrush body assembly 20 with an on/off switch 14, a handle grip 16, an audio grille 15, an audio chip device 21 with a group of encouraging and coaching messages, and a power access 22;
(c) a means to connect 18 the brush assembly 17 and the body assembly 20 to provide a rigid Training Toothbrush with Audio device 10; and
(d) a means to power and energize the brush assembly 17 and the audio chip device 21
whereby the toothbrush is use with children and the messages played from the audio chip aids in the development and training of good dental hygiene.

3. A toothbrush 10 according to claim 2, wherein the on/off switch 14 comprises an electronic switch member and a water impermeable membrane covering the electronic switch member to prevent water damage to the sound generating device and the electronic switch member.

4. A toothbrush according to claim 2, wherein the sound generating device comprises an audio chip 21 with an electrical circuit and components for generating audible and encouraging words and sounds and a timer device for activating the electrical circuit to generate words and sounds for a predetermined time period.

5. A toothbrush according to claim 2, wherein the means to power and energize is a battery.

6. A toothbrush according to claim 5, wherein the battery is rechargeable.

7. A toothbrush according to claim 5, wherein the battery is disposable.

8. A toothbrush according to claim 2, wherein the means to power and energize is by plugging the device into an electrical outlet.

9. A system and a method for teaching correct dental hygiene, and specifically, the brushing of teeth.

10. A method according to claim 9 comprised of performing the following steps:
STEP 1: insert the rechargeable batteries therein the apparatus 10
STEP 2: insert the desired toothbrush head 13 therein the body 20 utilizing the connector linkage
STEP 3: apply toothpaste thereon the bristles 12
STEP 4: power the apparatus 10 after charging by depressing the on/off button 14 or rocker switch to the “on” position
STEP 5: follow the coaching instructions throughout the entire duration envisioned to be approximately two (2) minutes as recommended by the American Dental Association
STEP 6: rinse off the bristles 12 embedded therein the head 13
STEP 7: store appropriately including plugging the apparatus 10 into art electric outlet for charging if needed
STEP 8: Repeat at appropriate time

11. A method according to claim 9 comprised of performing the following steps:
STEP 1: plug the apparatus 10 into an electric outlet
STEP 2: insert the desired toothbrush head 13 therein the body 20 utilizing the connector linkage
STEP 3: apply toothpaste thereon the bristles 12
STEP 4: power the apparatus 10 after charging by depressing the on/off button 14 or rocker switch to the “on” position
STEP 5: follow the coaching instructions throughout the entire duration envisioned to be approximately two (2) minutes as recommended by the American Dental Association
STEP 6: rinse off the bristles 12 embedded therein the head 13
STEP 7: store appropriately
STEP 8: Repeat at appropriate time
